(19) United States
(12) Patent Application Publication
(10) Pub. No.: US 2012/0175325 A1
(43) Pub. Date: Jul. 12, 2012

(54) Apparatus for housing, storing and organizing sponges and method of manufacutring same

(76) Inventors: Jill C. Del Grippo, Bedminster, NJ (US); Gregory A. Del Grippo, Bedminster, NJ (US)

(21) Appl. No.: 12/930,593

(22) Filed: Jan. 11, 2011

(51) Int. Cl. A47F 7/00; G09F 3/00; B23P 17/04

(52) U.S. Cl. 211/59.4; 29/428; 40/299.01

(57) ABSTRACT

A sponge holder simultaneously houses a plurality of sponges in an organized manner so that each sponge is separated and can be readily accessed and removed as needed. The sponge holder includes a base member extending on a horizontal plane and a rod support member terminating at the base member and extending upward on a vertical plane forming an angle theta along the horizontal plane and the base member. Two or more sponge trays are located on the rod support member. The sponge trays are appointed to each house a sponge thereon. The sponge trays are arranged horizontally so that the sponge rests on the sponge's broad side in a substantially flat manner to mitigate sponge dripping. The sponge trays are substantially parallel to one another on the vertical plane. Advantageously, each sponge can be readily accessed and removed as needed in any order and cross contamination between sponges is avoided.

### BACKGROUND OF THE INVENTION

1. Field of the Invention

The present invention relates to the storage and organization of sponges; more particularly, to an apparatus and method for housing, storing and organizing sponges, in which a rod support member extends on a vertical plane and terminates at a base member, and two or more sponge trays are located on the rod support member for housing a sponge thereon, whereby each sponge can be readily accessed and removed as needed in any order.

2. Description of the Prior Art

Frequently sinks become cluttered with sponges. As one of the sponges is reused for varying tasks, it becomes contaminated with bacteria and debris. Typically sponges are stored within the sink or on the sink edge. Unfortunately, sinks are breeding grounds for bacteria and other contaminants. As the sponge sits, it absorbs the bacteria, only to later spread the germs to other nearby sponges or to portions of the sink or countertop when the user is cleaning these items with the sponge. Over time, owing to the cross-contamination of different sponges and storage in or near contaminated sink surfaces, sponges become infested with germs and bacteria.

Although various sponge holders have been proposed, there remains a need in the art for a method and means that facilitates an orderly, organized sponge arrangement which offers complete accessibility and a clean aesthetically appealing sink area.

Surgical and medical device sponge delivery devices have been proposed. These sponge devices are appointed for use with surgical sponges; they provide sanitary sponges during operating procedures. Generally the surgical related sponge holders and dispensers proposed involve delivery of successive sponges in an ordered manner and involve the ability to count and return sponges to ensure all sponges are accounted for after surgery or operations. Examples of sponge holders directed to surgical and medical fields include the following patent disclosures. U.S. Pat. No. 2,588,110 to Halliday discloses a sponge counter holder for surgical sponges that requires a surgeon or nurse to remove sponges for use in a predetermined order and prevent replacement of sponges out of sequence wherein a plurality of rings are positioned in association with rotating disks; U.S. Pat. No. 4,903,837 to Duello discloses a dispenser which may be sealed and sterilized and contains surgical absorbent pads associated with an indicator strip for use during surgical operations so that spent absorbent pads are reassociated with the exterior indicator strips to provide a visual positive accounting of absorbent pads used during the operation; U.S. Pat. No. 4,966,595 to Meringola et al. discloses a surgical sponge assembly which includes in combination, a plurality of multi-layer gauze fabric bodies each having a twill strip of greater length than the length of the gauze body and a slotted strip having a plurality of slots equal in number to the number of twill strips; and U.S. Pat. No. 6,481,040 to Mcintyre discloses a modular surgical prep sponge holder for improving the cleaning of hands and arms prior to medical procedures. These surgical sponge devices are not structurally capable for providing in home use for a consumer, and do not disclose a sponge holder apparatus capable of holding two or more sponge trays wherein each sponge can be readily accessed and removed as needed in any order.

Sponge holder/delivery devices have been proposed for providing storage of sponges in relation to a kitchen or bathroom sink. However, these sponge holder devices fail to provide more than one slot for holding sponges. Consequently, only one sponge can be held on the device. Single sponge storage devices examples include: U.S. Pat. No. 7,665,634 to Pressler discloses a combination dispenser and implement holder, wherein the combination comprises a plurality of containers, each adapted to retain a liquid, a towel rack and a sponge holder; U.S. Pat. No. D354,873 to Odbert discloses an ornamental design for a sponge holder constructed with an attachment, likely a suction cup, located on the rear portion of the holder and a bracket for housing a sponge; U.S. Pat. No. D436,276 to Fiegl et al. discloses an ornamental design for a sponge holder constructed with a single basket appointed to receive a sponge; U.S. Pat. No. D453,651 to Snell discloses an ornamental design for a soap and sponge holder constructed generally as a basket with suction cups located on the rear of the basket; U.S. Pat. No. D486,336 to Snell discloses an ornamental design for a soap and sponge caddy constructed generally as a container attached to a soap dispensing bottle; U.S. Pat. No. D553,820 to Baumgart et al. discloses an ornamental design for a sponge holder generally constructed with a sponge basket with wall attachment/mounting means; U.S. Pat. No. D553,888 to Pressler discloses an ornamental design for a sink organizer generally constructed having a plurality of containers (in this case, three) for retaining a liquid, a towel rack projects from at least one side wall of at least one container, and preferably a sponge holder projects from the same wall below the towel rack; and Foreign Patent Publication No. AU2001100472 to Eishou discloses a sponge holder device generally of u-shaped cross section and having sufficient length to adequately support a sponge. These sponge holders do not teach a device that can hold a plurality of sponges. Rather these devices are only structured to house a single sponge. If more than one sponge were to be crammed into the devices, the arrangement would become disorganized and promote cross-contamination of the stored sponges.

Additional sponge holders have been proposed for providing storage of sponges in relation to a kitchen or bathroom sink that involves long horizontal, or shelve type units that rest on or near the sink edge and are appointed to hold soap containers, sponges, and other sink related items. Examples of these units include: U.S. Pat. No. 7,438,271 to Iannace discloses a holder and wringer for a sponge that includes a sheet of material holding the sponge and resting in a soap dish having a liquid soap dispenser thereon; U.S. Pat. No. 7,578,399 to Mulaw discloses a splash guard organizer for a sink work space including a vertical back panel with a number of spaced horizontal slots, a flexible water seal located at the bottom of the panel, and a hand access for operation of the water valve; U.S. Patent Application Publication No. 20040099617 to Elias et al. discloses an organizer for holding dishes, pots, pans, flatware, and other kitchen ware or utensils situated over the sink; and U.S. Patent Application Publication No. 20060289372 to Yang et al. discloses an organizer adapted for use adjacent a kitchen sink having an elongated rack portion having a front frame defining a curved open space at about the center to accommodate the faucet of a kitchen sink. These proposed sponge holders are generally large and cumbersome and tend to take up a significant amount of space above/near the sink.

Sponge caddies have been proposed that generally include soap dispensers with slots for housing a sponge. Examples of these sponge cadies include: U.S. Pat. No. D341,973 to Gerstmar discloses an ornamental design for a combination sponge caddy and fluid dispenser housing generally constructed to include a soap dispensing side and a storage side for holding sponges and or other items can be stored on the storage side; U.S. Pat. No. D531,844 to Snell discloses an ornamental design for a soap and sponge caddy generally constructed with a soap dispenser attached to two compartments appointed to receive sponges; and Non-Patent Literature entitled “Organize It” found at http://storage.organizeit.com/storage/kitchen%20sponge%20holders discloses various sponge holders offered on the market generally having small single or two sponge storage capability. None of these proposed devices are capable of holding a plurality of sponges constructed having a vertically extending rod with sponge trays arranged latitudinal thereon.

There remains a need in the art for a method and means for tidy, sanitary storage and organization of sponges. Also needed is a more hygienic arrangement, wherein the sponges are stored away from debris and contaminants and are stored separately from one another. Further needed is a more orderly, organized work space that facilitates rapid selection of a designated sponge without digging and searching for the desired sponge. At the same time, the sponge holder provides a more aesthetically appealing sink area.

### SUMMARY OF THE INVENTION

The present invention is directed to a sponge holder that simultaneously houses a plurality of sponges in an organized manner so that each sponge is separated and can be readily accessed and removed as needed. The sponge holder includes a base member extending on a horizontal plane and a rod support member terminating at the base member and extending upward on a vertical plane forming an angle theta along the horizontal plane and the base member. Two or more sponge trays are located on the rod support member. The sponge trays are appointed to each house a sponge thereon. The sponge trays are arranged substantially horizontally and substantially parallel to each other and to the base, so that the sponge rests on the sponge's broad side in a substantially flat manner to mitigate sponge dripping. The sponge trays are substantially parallel to one another on the vertical plane. Advantageously, each sponge can be readily accessed and removed as needed in any order and cross contamination between sponges is avoided.

The sponge holder offers a method and means for tidy, sanitary storage and organization of one's sponges. A more sanitary condition is provided by the sponge holder as the sponges are stored away from debris and contaminants and are stored separately from one another. Moreover, the user is provided with a more orderly, organized work space so that he/she can quickly grab a designated sponge without digging and searching for the desired sponge. At the same time, the sponge holder provides a more aesthetically appealing sink area.

In a first embodiment the sponge holder comprises a base member extending on a horizontal plane. The sponge holder further includes a rod support member terminating at the base member and extending upward on a vertical plane forming an angle theta along the horizontal plane and the base member. Additionally, two or more sponge trays are located on the rod support member, each adapted to house a sponge thereon. The sponge has a top and bottom broad side and shallow side walls. The sponge trays are arranged horizontally so that the sponge rests on the broad side in a substantially flat manner. The sponge trays are substantially parallel to one another on the vertical plane. Each sponge can be readily accessed and removed as needed in any order.

A method for making a sponge holder is also provided. The steps of the method include: forming a base member extending on a horizontal plane; forming a rod support member terminating at the base member and extending upward on a vertical plane forming an angle theta along the horizontal plane and the base member; and forming two or more sponge trays and attaching same on the rod support member each for housing a sponge thereon, the sponge having a top and bottom broad side and shallow side walls, the sponge trays being arranged horizontally so that the sponge rests on the broad side in a substantially flat manner, and wherein the sponge trays are substantially parallel to one another and to the base on the vertical plane, whereby each sponge can be readily accessed and removed as needed in any order.

### BRIEF DESCRIPTION OF THE DRAWING

The invention will be more fully understood and further advantages will become apparent when reference is had to the following detailed description of the preferred embodiments of the invention and the accompanying drawings, in which:

FIG. 1 illustrates a front view of an embodiment of the sponge holder;

FIG. 2a shows a cross-sectional view of an embodiment of the sponge holder wherein θ is 90°;

FIG. 2b shows a cross-sectional view of an embodiment of the sponge holder wherein θ is 80°;

FIG. 2c shows a cross-sectional view of an embodiment of the sponge holder wherein θ is 60°;

FIG. 2d shows a cross-sectional view of an embodiment of the sponge holder wherein θ is 50°;

FIG. 3 illustrates a view of an embodiment of the sponge tray of the sponge holder;

FIG. 4 illustrates a front view of another embodiment of the sponge holder;

FIG. 5 illustrates a view of a sponge tray of the sponge holder;

FIG. 6 illustrates a side view of the embodiment of the sponge holder depicted by FIG. 4; and

FIG. 7 illustrates a front view of another embodiment of the sponge holder, wherein the sponge trays are spirally arranged on the rod support member.

### DETAILED DESCRIPTION OF THE INVENTION

This invention relates to an apparatus and method for housing, storing and organizing sponges. Particularly, the apparatus for housing, storing and organizing sponges is constructed having a rod support member extending on a vertical plane and terminating at a base member and two or more sponge trays located on the rod support member for housing a sponge thereon. Each sponge can be readily accessed and removed as needed in any order. The sponge holder offers a method and means for tidy, sanitary storage and organization of one's sponges. A more sanitary condition is provided by the sponge holder as the sponges are stored away from debris and contaminants and are stored separately from one another. Moreover, the user is provided with a more orderly, organized work space so that he/she can quickly grab a designated sponge without digging and searching for the desired sponge. At the same time, the sponge holder provides a more aesthetically appealing sink area.

The sponge holder comprises a base member extending on a horizontal plane. The sponge holder further includes a rod support member terminating at the base member and extending upward on a vertical plane forming an angle theta along the horizontal plane and the base member. Additionally, two or more sponge trays located on the rod support member each for housing a sponge thereon. The sponge has a top and bottom broad side and shallow side walls. The sponge trays are arranged horizontally so that the sponge rests on the broad side in a substantially flat manner. The sponge trays are substantially parallel to one another on the vertical plane. Each sponge can be readily accessed and removed as needed in any order.

In order to provide additional stability, the base member is preferably weighted with a thick discrete metal or ceramic block or the like located under the base member. As the base member is weighted, the base member's size can be decreased to provide a more compact device. The base member preferably has a height of inch, a width ranging from 3-6 inches, and a length ranging from 3-6 inches. A plethora of different shapes can be utilized in forming the base member. Preferably the base member has a polygonal shape. Most preferably the base member has a hexagonal shape, having 6 side walls for enhanced stability. Alternatively, the base member can have a substantially circular or elliptical shape.

The rod support member terminates at the base member at an angle theta along the horizontal plane. This provides for an inclined rod support member in relation to the base. Inclination of the rod support member provides additional stability to the sponge holder as the center of gravity is shifted, therefore the device is less prone to falling over. Also, inclination of the rod support member further provides the advantage of allowing the user to more easily reach the desired sponge while working at the sink. Typically the angle θ inclining from the horizontal ranges from approximately 50° to 90°. Preferably, θ ranges from approximately 60° to 80°.

The sponge trays are arranged horizontally stacked along the rod support member and are each appointed to receive a single sponge. This is to avoid cross-contamination between the sponges, while also providing a more aesthetic arrangement and making it easier to select the desired sponge. The trays are preferably rectangular, 3×5 inches, however the shelves/trays can be any general shape as long as the shape does not depart from the invention. For example, the trays may be rings, polygonal, etc. In any event, the sponge rests on its broad side when it is placed on the trays, on the horizontal plane, as opposed to being placed or stored in the upright position. It has been found that due to the horizontal attitude of the sponge, the water does not drip from the sponge during storage. Therefore, the sponge is less likely to dry out and become hard, and there is no drip issue to contend with, which would cause cross contamination to the lower lying sponges. Provision of ridges or nubs on the upper sides of the trays minimizes contact between the sponges and the trays, increasing air flow therebetween. This, in turn, facilitates drying of the sponges which, owing to their position on the trays dry evenly.

The sponge trays are substantially parallel to one another on the vertical plane. Each sponge can be readily accessed and removed as needed in any order. Preferably the trays are roughly 2.5-3.5 inches apart from one another. In one embodiment the trays are arranged in a spiraled configuration along the rod support member. This displaces the weight of the sponges and allows for a smaller base member. It also has been found to make it easier to select the desired sponge. There may be 2-6 trays; however 4 trays are most preferred. What is more, the trays may be removable to provide quick washing of the trays in the dishwasher or sink. Removal of the trays can be achieved by simply providing a tongue in the back of the tray that is received in a mating groove located on the rod support member for a snap on, snap off fit. Additionally, the rod support member may be snapped out or removed from the base member for convenient storage. Alternatively, the entire unit can be constructed of materials that are dishwasher safe. Inasmuch as the unit has a length at or under 12 inches, it is conveniently placed within a dishwasher to facilitate cleaning thereof. For use with industrial operations such as commercial kitchens, garages and the like, the unit can be adapted to interface with a wall mounted clamping system.

The sponge holder can be made of a variety of sizes, colors, and to match specific decor. Different sponge holders can be provided for different work spaces. For examples, there may be a kitchen, bathroom, automotive, and/or garage sponge holder, each specifically geared toward the given designation. The sponge holder can be made of a plethora of materials, including metal, stainless steel, brushed steel, plastic, acrylic (transparent or opaque), and/or painted with designs, wood portions, ceramic portions and textures (like stoneware pieces). Additionally, the sponge holder can come in a wide spectrum of colors and/or can be made to match countertops or other décor within a kitchen, bath, garage, or the like. Optionally, the support rod can be provided with an attachment means, such as a hook or the like, for connection to a vegetable sponge, bottle brush, or the like.

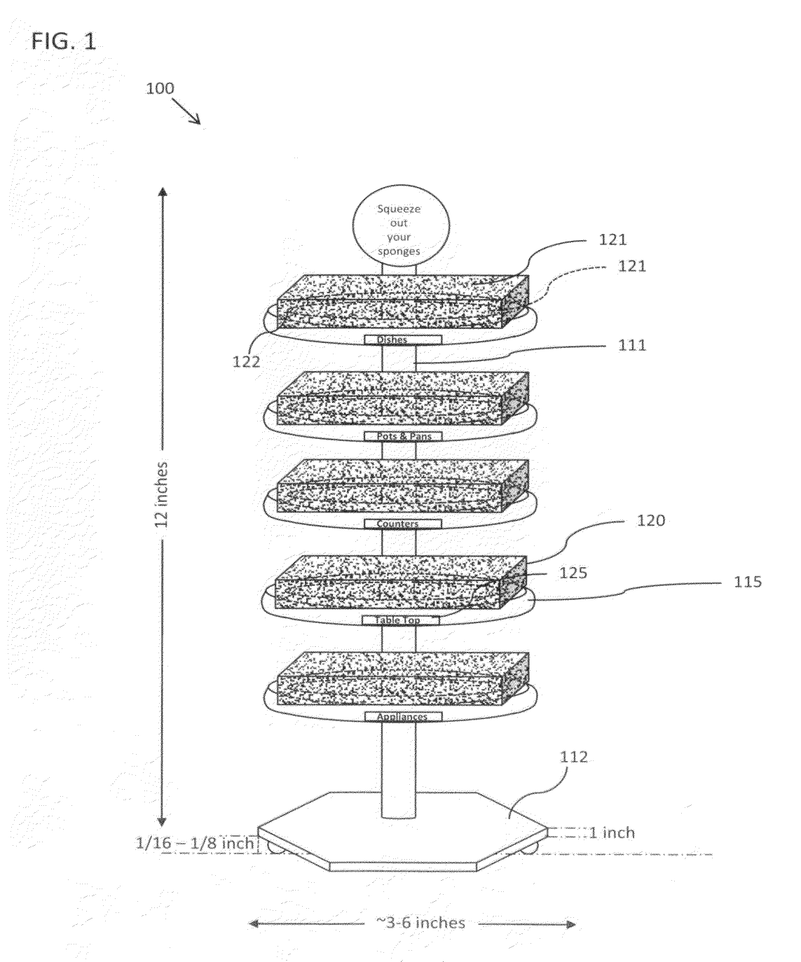

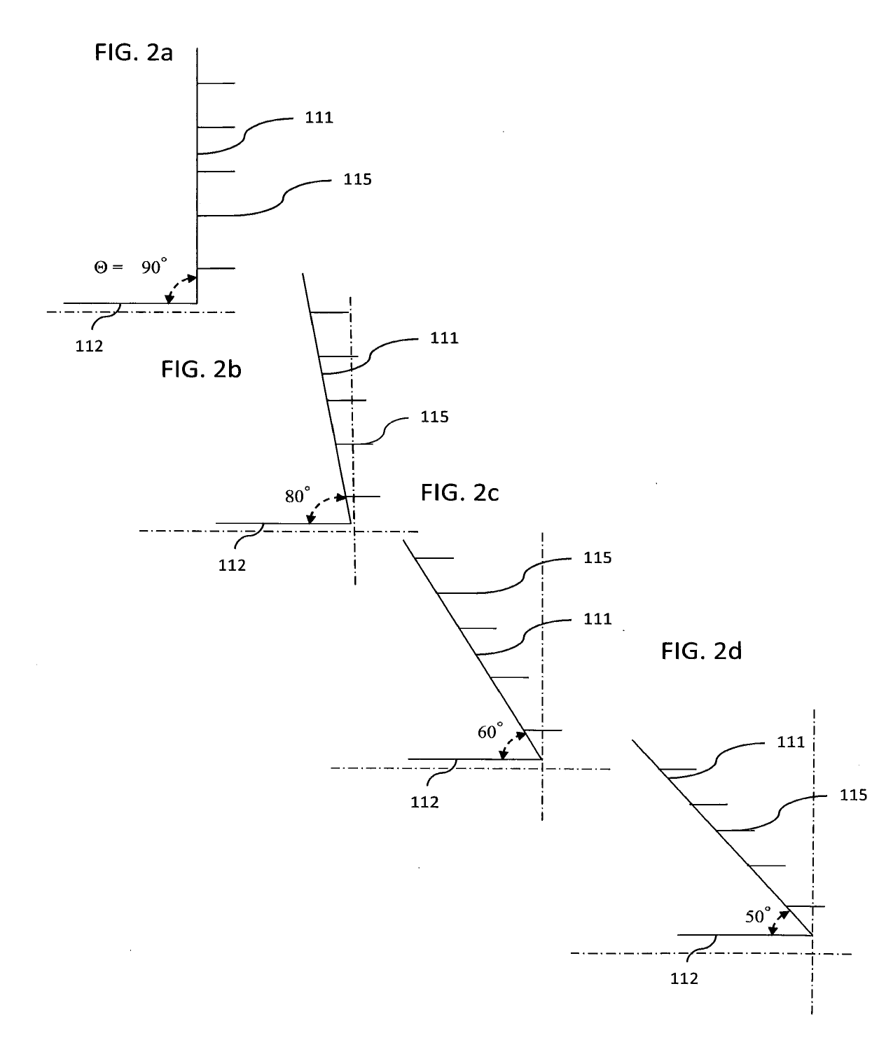

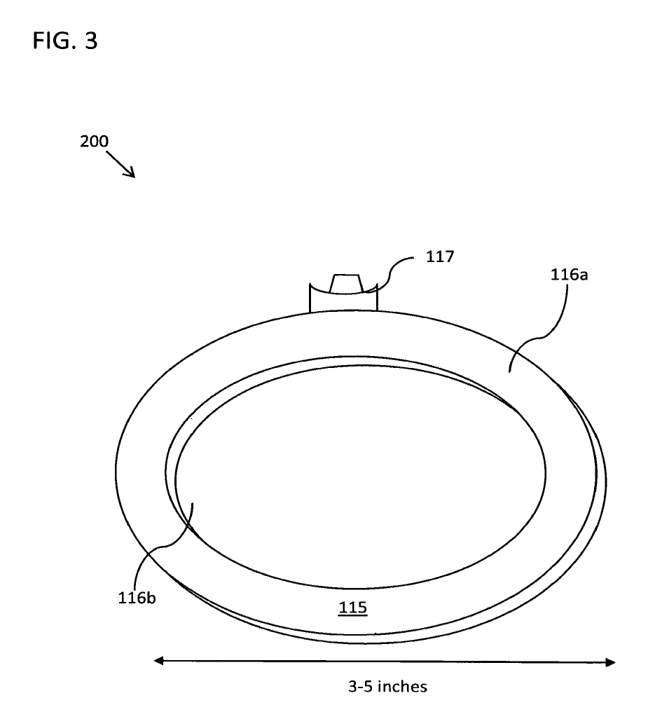

FIG. 1 illustrates a front view of an embodiment of the sponge holder, shown generally at 100. FIGS. 2a-2d show cross-sectional views of the proposed inclines of the rod support member in relation to the base member, wherein FIG. 2a shows a θ of ˜90°, FIG. 2b shows a θ of ˜80°, FIG. 2c shows a θ of ˜60°, and FIG. 2d shows a θ of ˜50°. FIG. 3 illustrates a view of an embodiment of the sponge tray of the sponge holder, shown generally at 200.

Referring to FIGS. 1-3, the sponge holder 100 comprises a base member 112 extending on a horizontal plane. The sponge holder further includes a rod support member 111 terminating at the base member 112. The rod support member 111 extends upward on a vertical plane forming an angle theta θ along the horizontal plane and the base member 112. Additionally, two or more sponge trays 115 are located on the rod support member 111. Each sponge tray 115 is appointed for housing a sponge 120 thereon. The sponge 120 is a typical sponge, including a top and bottom broad side 121 and shallow side walls 122. The sponge trays 115 are arranged horizontally so that the sponge 120 rests on the broad side 121 or in a horizontal attitude in a substantially flat manner on tray 115. The horizontal attitude of the sponge 120 tends to render less dripage from the sponge; as opposed to storage of the sponge 120 on one of its shallow side walls 122 which tends to cause more dripage. The sponge trays 115 are substantially parallel to one another on the vertical plane. Each sponge 120 can be readily accessed and removed as needed in any order. Trays 115 may include indicia 125 to designate the sponge 120 held thereon.

Rod support member 111 angle theta θ along the horizontal plane and the base member 112 preferably ranges from 50 to 90 degrees. FIG. 2a-2d illustrate the different angles of incline. FIG. 2a illustrates θ of ˜90°, FIG. 2b shows a θ of ˜80°, FIG. 2c shows a θ of ˜60°, and FIG. 2d shows a θ of ˜50°. Inclination of the rod support member provides additional stability, and the advantage of allowing the user to more easily reach the desired sponge while working at the sink.

The sponge tray 115 can be a plethora of shapes. Herein the tray is shown as a ring structure, best illustrated in FIG. 3. The ring structure includes a ring 116a with a hollow core 116b and an arm member 117 for attachment to rod support member 111.

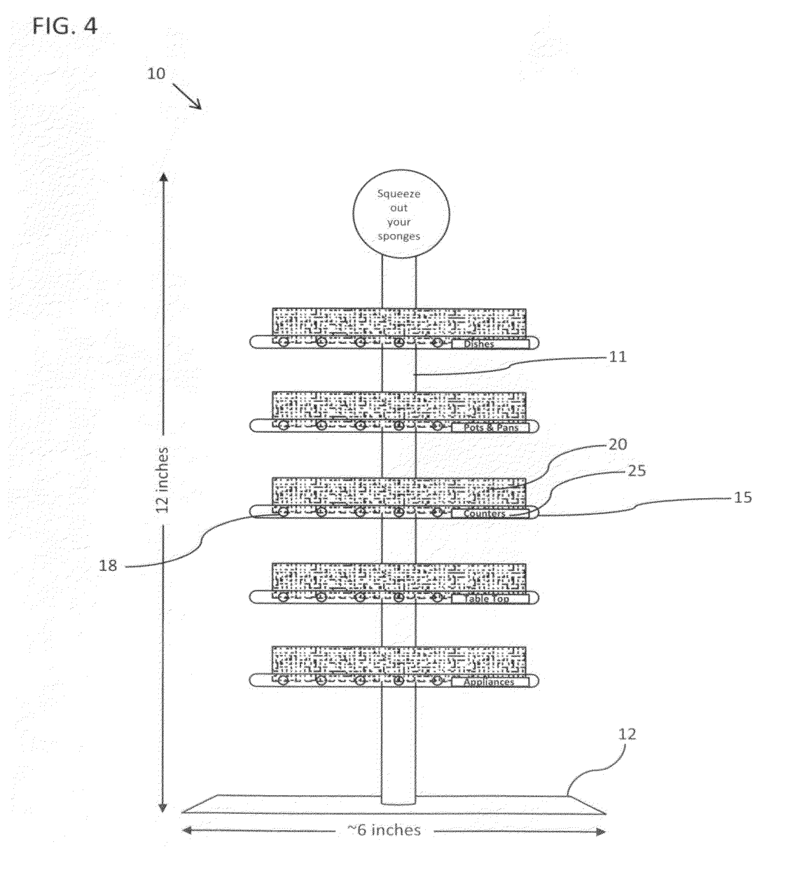

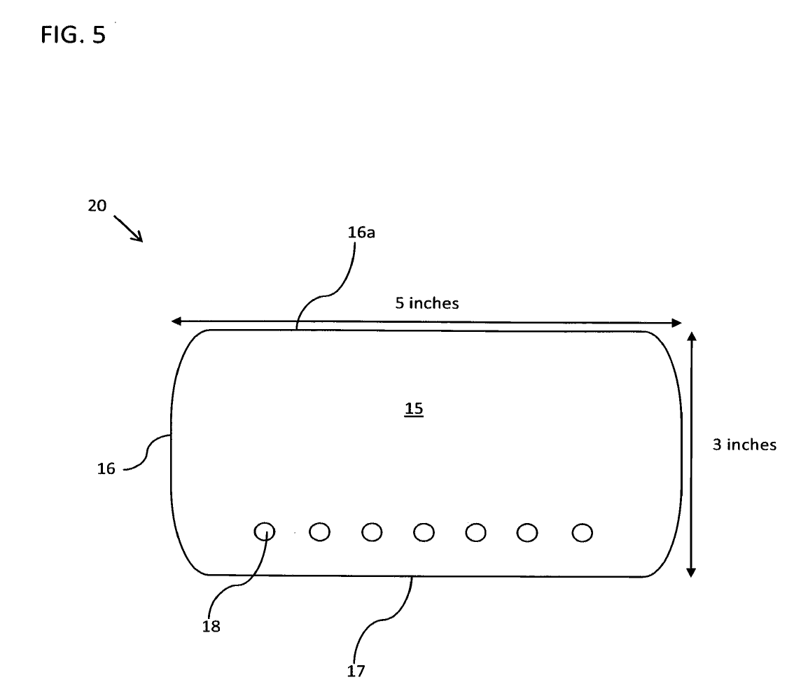

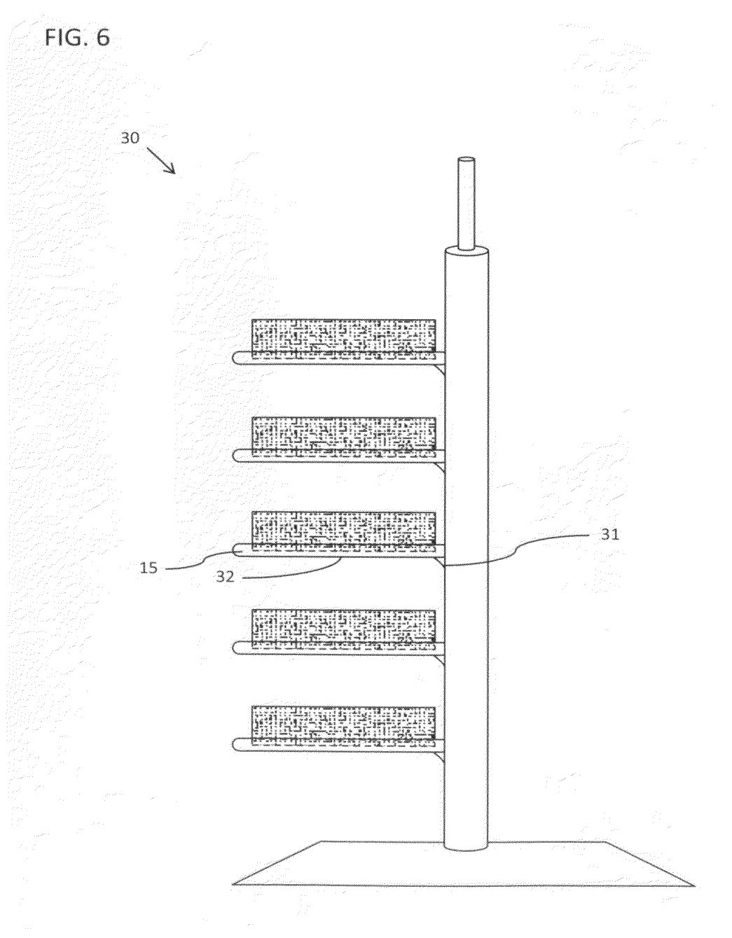

FIG. 4 illustrates a front view of an embodiment of the sponge holder, shown generally at 10. FIG. 5 illustrates a view of a sponge tray of the sponge holder, shown generally at 20. FIG. 6 illustrates a side view of the embodiment of the sponge holder depicted by FIG. 4, shown generally at 30.

Referring to FIGS. 4-6, the sponge holder is associated with an apparatus and method for housing, storing and organizing sponges. The sponge holder generally includes a rod support member 11 terminating at a base member 12 and extending upward on a vertical plane X. Rod support member 11 is preferably a rod type element. Preferably, rod support member 11 is approximately 12 inches in height. Base member 12 is provided to stabilize rod support member 11. Preferably, base member 12 is sized, shaped, and/or weighted in order to prevent rod support member 11 and visa via sponge holder 10 from falling or topping over. The base member can also be provided with a non-slip pad composed of rubber or felt inset to protect the substrate therebeneath and prevent the base from slipping. Base member 12 may be approximately 6 inches in length. A stabilizing weight may be integrated within base member 12. For industrial purposes, the size of the base can be increased or extended, as needed, to counterbalance the weight of the unit. Additionally, or alternatively, a stabilizing pad (such as a rubber pad/or felt pad) is attached via adhesive to the bottom of the base member 12 so that it does not slide on the sink or counter surface where the sponge holder is resting.

At least one sponge tray 15 is located on said rod support member 11 for housing a sponge thereon. Sponge tray 15 may be fixedly attached by way of arm member 31 (see FIG. 6) wherein arm member 31 is attached to rod support member 11. Moreover, sponge tray 15 may be comprised of two portions: a holding tray 32 and the arm member 31. Holding tray 32 may be removable via snap removal from arm member 31 so that the holding tray 32 may be removed for cleaning, and/or can be disposed of and replaced with a new tray 32. Alternatively, holding tray 32 and arm member 31 is a unitary, single bodied construction. In this embodiment, arm member 31 and corresponding holding tray 32 are preferably removable from rod support member 11 for cleaning and/or replacement as necessary. Optionally, the top of the rod support member 11 can be provided with a ring, ball or like member to facilitate portage or storage of the unit. A ball or ring is readily grasped, and can be configured to interface with a hook, clasp or the like, enabling the unit to be placed beneath a sink or in a cupboard.

Preferably, as shown in FIGS. 4 and 6, the sponge holder includes a plurality of sponge trays 15. Each sponge tray 15 is appointed to accommodate a sponge 20 thereon. Preferably, each sponge tray 15 includes indicia thereon shown at 25 directed to a specific-job related sponge. Preferably, there are at least five sponge trays 15. Specific job related sponges housed on each tray may include, for examples, a sponge for “Dishes”, “Pots & Pans”, “Counter”, “Table Top”, and “Appliances”. Moreover, each of the sponge trays 15 preferably includes shallow side walls 16 abutting a bottom wall 17. Side walls 16 preferably have a height of approximately 3 inches for a 3 inch depth in retaining sponge 20. Front side walls 16a are provided with lateral side walls. Front side walls 16a are preferably approximately 5 inches in length. A plurality of apertures 18 are preferably integrated within either the side walls 16 and/or bottom wall 17 if drainage occurs.

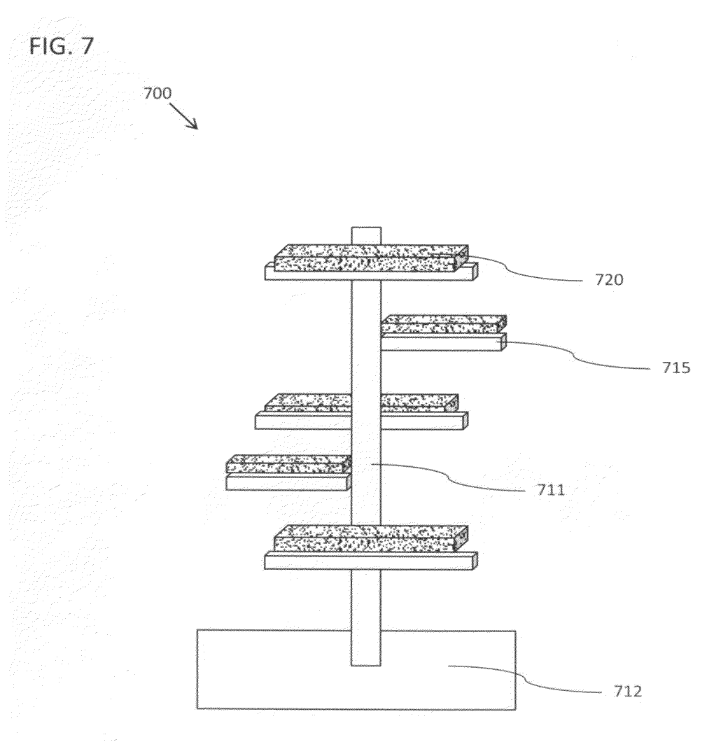

FIG. 7 illustrates a front view of another embodiment of the sponge holder, wherein the sponge trays are spirally arranged on the rod support member, shown generally at 700. The sponge holder 700 comprises a base member 712 extending on a horizontal plane and a rod support member 711 terminating at the base member 712. The rod support member 711 extends upward on a vertical plane forming an angle theta θ along the horizontal plane and the base member 712. Two or more sponge trays 715, preferably 4 trays 715, are located on the rod support member 711. Each sponge tray 715 is appointed for housing a sponge 720 thereon. The sponge trays 715 are herein shown arranged in a spiral configuration along rod support member 711. The spiral arrangement results in displacement of the weight of the sponges and allows for a smaller base member. It also has been found to make it easier to select the desired sponge.

The sponge holder disclosed herein can be modified in numerous ways without departing from the scope of the invention. Optional sizes, shapes, and raw materials may be used, as well as colors and the like.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A sponge holder, comprising:
a. a base member extending on a horizontal plane;
b. a rod support member terminating at said base member and extending upward on a vertical plane forming an angle theta along said horizontal plane and said base member; and
c. two or more sponge trays located on said rod support member each for housing a sponge thereon, said sponge having a top and bottom broad side and shallow side walls, said sponge trays being arranged horizontally so that said sponge rests on said broad side in a substantially flat manner, said sponge trays being substantially parallel to one another on said vertical plane, whereby each sponge can be readily accessed and removed as needed in any order.

2. A sponge holder as recited by claim 1, wherein there are between 2 to 6 sponge trays.

3. A sponge holder as recited by claim 2, wherein there are 4 sponge trays.

4. A sponge holder as recited by claim 1, wherein each said sponge tray is appointed to accommodate a single sponge.

5. A sponge holder as recited by claim 1, wherein each said sponge tray includes indicia thereon directed to a specific job related sponge.

6. A sponge holder as recited by claim 5, wherein said specific job related sponges include a dish sponge, pots & pans sponge, counter sponge, and a table top sponge.

7. A sponge holder as recited by claim, wherein said sponge trays comprise shallow side walls.

8. A sponge holder as recited by claim 1, wherein said sponge trays comprise a plurality of apertures integrated therein for drainage.

9. A sponge holder as recited by claim 1, wherein said sponge trays comprise rings.

10. A sponge holder as recited by claim 1, wherein said sponge trays are arranged in a spiraled configuration along said rod support member.

11. A sponge holder as recited by claim 1, wherein said base member is weighted for stability.

12. A sponge holder as recited by claim 1, wherein said angle theta ranges from 50°-90° from said base member on said horizontal plane.

13. A sponge holder as recited by claim 1, wherein said angle theta ranges from 60°-80° from said base member on said horizontal plane.

14. A sponge holder as recited by claim 1, wherein said base member is a hexagon.

15. A sponge holder as recited by claim 1, wherein said base member is a polygon.

16. A sponge holder as recited by claim 1, wherein said sponge trays are removable.

17. A method for making a sponge holder, comprising the steps of:
a. forming a base member extending on a horizontal plane;
b. forming a rod support member terminating at said base member and extending upward on a vertical plane forming an angle theta along said horizontal plane and said base member; and
c. forming two or more sponge trays and attaching same on said rod support member each for housing a sponge thereon, said sponge having a top and bottom broad side and shallow side walls, said sponge trays being arranged horizontally so that said sponge rests on said broad side in a substantially flat manner, and wherein said sponge trays are substantially parallel to one another on said vertical plane, whereby each sponge can be readily accessed and removed as needed in any order.
